(19) United States
(12) Patent Application Publication
(10) Pub. No.: US 2005/0204918 A1
(43) Pub. Date: Sep. 22, 2005

(54) HEPA air scrubber or negative air pressure machine

(76) Inventor: James Brown, Ithaca, NY (US)

Correspondence Address: BROWN & MICHAELS, PC;400 M & T BANK BUILDING, 118 NORTH TIOGA ST, ITHACA, NY, 14850, US

(21) Appl. No.: 10/805,022

(22) Filed: Mar. 19, 2004

(51) Int. Cl. B01D 46/00

(52) U.S. Cl. 95/273; 55/467; 55/490

(57) ABSTRACT

The invention converts an air mover into an inexpensive, lightweight, portable high efficiency particulate air (HEPA) filtration system. The air filtration system is preferably used either for light-duty or heavy-duty air filtration. Light-duty operation involves strapping a HEPA filtration bag over the exhaust vent of the air mover. Heavy-duty operation involves attachment of a HEPA filter encased in a hard metal or plastic shell to the exhaust vent of the air mover by a flexible sleeve. A conversion kit for converting an air mover to a HEPA filtration system and a method of converting an air mover to a HEPA filtration system are also disclosed.

### BACKGROUND OF THE INVENTION

1. Field of the Invention

The invention pertains to the field of air filtration. More particularly, the invention pertains to a portable air scrubber or negative air machine for high efficiency particulate air (HEPA) filtration.

2. Description of Related Art

In the disaster restoration, mold remediation, and asbestos abatement industries the use of air scrubbers and negative air machines is vital. The HEPA air scrubber and negative air machine are used primarily to establish a condition of “negative air pressure” in a contained work space to help prevent the escape of spores, asbestos, or other contaminants from the contained work area on air currents flowing outside of the containment. The air flowing outward from the contained space is “positive air pressure.” Negative air machines and HEPA air scrubbers cause air to flow into the contained workspace at a greater pressure than the positive pressure trying to escape the contained area. The secondary purpose of these machines is to clean the air by trapping the airborne contaminants within their HEPA filtration. Both devices pull air through a filter or filters to remove impurities from the air, and both move 500 to 5000 cubic feet of air per minute (CFM). Air scrubbers and negative air machines are very expensive and in high demand.

Negative air machines have been used for asbestos abatement since approximately 1980. These machines are generally designed to minimize cost for a given air flow rate for the blower, and they work best for longer-duration projects, where minimal movement of the machine is required. Negative air machines weigh up to 400 pounds, and since they typically move the air horizontally, they are generally longer than they are tall.

Air scrubbers also work by use of negative air pressure, but they are designed to be smaller and more portable than negative air machines. They are generally used for filtering mold, bacteria, smoke, odors, and volatile organic compounds out of the air. These units are generally upright with air flowing vertically through them. Air scrubbers are often mounted on a transport cart for greater maneuverability.

Herein the term “negative air apparatus” will be used to encompass both negative air machines and air scrubbers.

Stand-alone high-velocity air movers are used for restorative drying. A “high-velocity” air mover is herein defined as an apparatus, which moves at least 500 cubic feet of air per minute. Air movers lift moisture from wet materials and evaporate it into the air by blowing high-velocity air across a wet surface. A common application is drying carpets and area rugs. Stand-alone air movers designed for carpet drying are typically compact in structure, funnel air movement through a snout-shaped exhaust vent, and can move up to 3500 CFM of air. Exemplary examples of stand-alone high-velocity air movers are the Sahara TurboDryer® and the Sahara Pro-HP TurboDryer®, both of which are manufactured by Dri-Eaz. Another common application for high-velocity air movers is to dry wet building structures such as walls, floors, and ceilings. An additional application is pet drying.

There are a number of patented air filtration systems, which use HEPA filtration.

U.S. Pat. No. 4,778,496, HIGH EFFICIENCY PARTICULATE AIR FILTER CABINET, issued Oct. 18, 1988, describes a cabinet enclosing a high efficiency particulate air filter located in a first part of the cabinet. A second part of the cabinet contains the blower and its motor. A third part of the cabinet encloses the first part and provides a screened access opening so that air to be filtered can enter the third part of the cabinet and flow through the high efficiency particulate air filter in the first part of the cabinet and from the filter into the second part of the cabinet and the blower.

U.S. Pat. No. 5,078,764, AIR PURIFICATION APPARATUS, issued Jan. 7, 1992, discloses an air purification apparatus with an inner housing having an air inlet and an air outlet. The inner housing is made of sheet metal which can be contoured for mounting interior components, such as a blower and a HEPA filter, directly to the inner housing itself, without requiring extraneous mounting brackets or flanges. An outer housing is secured about the inner housing with portions spaced from the inner housing. The outer housing has an air inlet and an air outlet communicating respectively with the air inlet and the air outlet of the inner housing. Preferably, the outer housing is fabricated of molded plastic material, with integrally molded vertical reinforcing ribs, and a recessed integral ring about the outlet for storing an electrical cord. Closures are provided for the inlet and the outlet of the outer housing to seal the housing when the apparatus is not in use.

U.S. Pat. No. 5,578,113, AIR TREATMENT SYSTEM, issued Nov. 26, 1996, describes an air treatment system with a front cylindrical chamber and a rear rectangular chamber. The front chamber has a series of outlet vents, and the rear chamber has a series of inlet vents. A pair of electrically-powered cylindrical fan blades in the front chamber are used to draw air into the rear chamber. The second filter assembly, which is intended to be used when water is not present in the reservoir so as to provide only air purification, includes a HEPA filter and an activated charcoal filter, both of which are housed within a cardboard frame.

U.S. Pat. No. 5,616,172, AIR TREATMENT SYSTEM, issued Apr. 1, 1997, discloses a self-contained air movement system for air purification and infection control with an elongated, upright, enclosed housing including a base module, sidewalls, and an upper module. A fan intermediate to the base module and the upper module draws unclean air from a room through the base module, then discharges a purified air stream from the upper module. A pair of pre-filters are on the base module in a stacked relationship for trapping relatively large particulate matter from the entering air stream. The upper module includes a discharge grille opening to the environment with angled louvers for guiding and re-directing the purified air stream from a downstream HEPA-type filter into an inclined stream, flowing proximate to and along the ceiling of the room in which the system is located.

U.S. Pat. No. 5,997,619, AIR PURIFICATION SYSTEM, issued Dec. 7, 1999, describes a self-contained air purification system with an upright enclosed housing defining a germicidal chamber. A primary filter is supported on a base member. The housing has air inlets proximate to the filter and air exhaust louvers in an upper member. The primary filter includes an outermost particulate pre-filter for removal of particles of about 10-micron size and larger, an intermediate filter for removal of oxidizing gaseous pollutants, and an innermost HEPA filter.

Despite the existence of many types of air filtration systems, commercially available air scrubbers and negative air machines with HEPA filtration capabilities are heavy and expensive. A negative air machine capable of filtering 2000 cubic feet of air per minute costs between $800 and $1600, weighs in excess of 150 pounds, and has base dimensions of two feet by three feet. An air scrubber capable of filtering 2000 cubic feet of air per minute costs between $1600 and $3200, weighs in excess of 100 pounds, and has base dimensions of about two feet by two feet.

Therefore, there is a need for a small, inexpensive, lightweight negative air apparatus that overcomes the shortcomings of the prior art.

### SUMMARY OF THE INVENTION

The invention converts an air mover into an inexpensive, lightweight, portable high efficiency particulate air (HEPA) filtration system. The air mover is preferably a stand-alone high-velocity air mover. The air filtration system is preferably used either for light-duty or heavy-duty air filtration. Light-duty operation involves strapping a HEPA filtration bag over the exhaust vent of the air mover. Heavy-duty operation involves attachment of a HEPA filter encased in a hard metal or plastic shell to the exhaust vent of the air mover by a flexible sleeve. A conversion kit for converting an air mover to a HEPA filtration system and a method of converting an air mover to a HEPA filtration system are also disclosed.

In a preferred embodiment, the light-duty air filtration system includes a high-velocity air mover including an exhaust vent, a fastener, and a high efficiency particulate air filtration bag including an open end covering the exhaust vent and attached to the high-velocity air mover by the fastener, wherein the fastener forms an airtight seal between the high-velocity air mover and the high efficiency particulate air filtration unit. The fastener is preferably an elastic band and an adhesive strip.

In another preferred embodiment, the heavy-duty air filtration system includes a high efficiency particulate air filtration unit, which further includes a shell having a first shell end and a second shell end, open to air flow on both ends, a high efficiency particulate air filter structure having a first structure end and a second structure end and encased in the shell and extending inward from the second shell end and the second structure end, a high efficiency particulate air filter at the second structure end, a pre-filter space defined by the shell, the first shell end, and the first structure end, and an airtight sleeve connecting the first shell end to the exhaust vent, wherein the sleeve is secured to the high-velocity air mover by the fastener. The fastener is preferably an elastic band and an adhesive strip.

In a further preferred embodiment, at least one pre-filter and at least one carbon filter are placed in a pre-filter space of the shell adjacent to the HEPA filter structure. Since the HEPA filter is permanently attached to the inside of the shell, the primary and secondary filters are in the shell to protect the HEPA filter from filling up with large and medium size particles, and therefore they lengthen the life of the HEPA filter. The primary and secondary filters can be removed, vacuum-cleaned, and returned to or replaced with new filters in the shell. The carbon filter is optional and is for odor removal only. It is removably placed next to the HEPA filter and after the primary and secondary filters. In this case the primary and secondary filters extend the life of both the carbon filter and the HEPA filter.

In yet another preferred embodiment, a conversion kit for converting a high-velocity air machine into an air filtration system having a high efficiency particulate air filtration capacity includes a high efficiency particulate air filtration unit comprising an open end of a size to cover the exhaust vent of the high-velocity air mover and a fastener for attaching the open end of the high efficiency particulate air filtration unit to the exhaust vent of the high-velocity air mover, wherein the fastener forms an airtight seal between the high-velocity air mover and the high efficiency particulate air filtration unit. The fastener is preferably an elastic band and an adhesive strip.

In yet another preferred embodiment, a method of converting a high-velocity air mover into an air filtration system having a high efficiency particulate air filtration capacity includes the steps of providing a high-velocity air mover including an exhaust vent, providing a fastener, providing a high efficiency particulate air filtration unit, and attaching the high efficiency particulate air filtration unit to the exhaust vent by the fastener, thereby forming an airtight seal between the high-velocity air mover and the high efficiency particulate air filtration unit. The fastener is preferably an elastic band and an adhesive strip.

### BRIEF DESCRIPTION OF THE DRAWINGS

FIG. 1 shows an embodiment of the invention for light-duty use.

FIG. 2 shows an exploded view of the embodiment of FIG. 1.

FIG. 3 shows an embodiment of the invention for heavy-duty use.

FIG. 4A shows an exploded view of the embodiment of FIG. 3.

FIG. 4B shows a further exploded view of the embodiment of FIG. 3.

### DETAILED DESCRIPTION OF THE INVENTION

The present invention converts an air mover into an inexpensive, lightweight, portable HEPA negative air apparatus. A high-velocity air mover weighing only 29 pounds and measuring less than 20 inches in each dimension moves up to 2700 cubic feet per minute (CFM) and is commercially available for approximately $250. An upgrade capable of 3500 CFM has the same weight and dimensions but requires a more powerful motor and is more expensive at approximately $375.

The present invention attaches a HEPA filtration unit to an air mover to create a HEPA filtration unit at a fraction of the cost and weight of commercially available negative air apparatuses. The HEPA filtration unit is preferably a HEPA air scrubber or a negative air machine. The resistance provided by the filtration unit slows the air flow to some degree, typically about 15% for a new filter, but a negative air apparatus of the present invention using a 2700 CFM air mover equals or exceeds the air flow of a commercial 2000 CFM negative air machine or air scrubber under most air filtration conditions.

For light-duty air filtration, a large bag made of high efficiency particulate air (HEPA) filtration paper is open at one end. The open end of the HEPA bag fits around the exhaust vent of a high-velocity air mover and is secured to the air mover by a fastener, preferably a four-inch wide adhesive strip and an elastic band. Any fastener, which secures the filtration unit to the exhaust vent of the air mover and provides an airtight seal, is within the spirit of the invention. The cross-sectional dimensions of the bag are slightly larger than the dimensions of the exhaust vent on the air mover. When the air mover is activated, the HEPA bag quickly scrubs the air clean of airborne debris such as dust, sawdust, sheetrock dust, and dirt. The bag is preferably replaced when half-full.

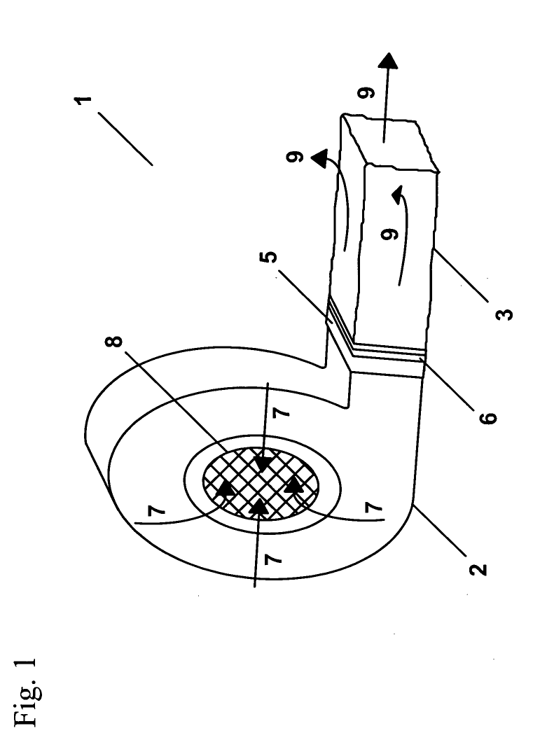

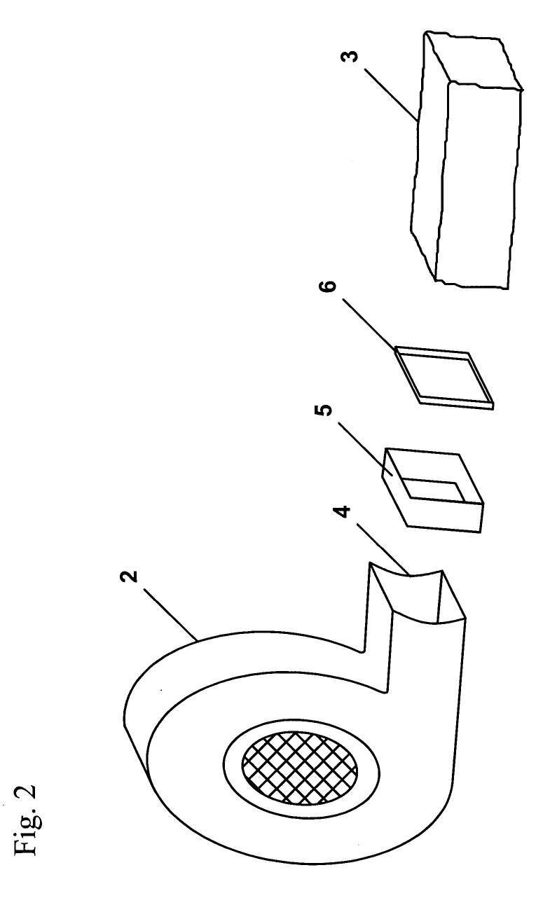

Referring to FIGS. 1 and 2, an embodiment of the present invention adapted for light-duty air filtration is shown. The light-duty negative air apparatus (1) has a stand-alone high-velocity air mover (2) attached to a HEPA filter bag (3), which is open at one end. The negative air apparatus (1) of the present invention is preferably either a negative air machine or an air scrubber, depending on the industrial application. The open end of the filter bag (3) is secured over the snout or exhaust vent (4) of the high-velocity air mover (2) with an adhesive strip (5) and an elastic band (6). The exploded version, shown in FIG. 2, allows a better view of the exhaust vent (4) of the air mover, from which air exits the air mover during operation.

To operate the negative air apparatus (1), the apparatus is assembled and placed in the space where the air is to be filtered. The high-velocity air mover (2) is activated. Dirty air (7) is drawn by negative air pressure into the two sides (8) of the high-velocity air mover. The dirty air (7) is pushed out the exhaust vent (4) of the air mover and pushed through the HEPA filtration material of the filter bag (3), where it is filtered and exits the bag as clean, filtered air (9). Air filtration preferably continues until either the bag (3) becomes half-full with dirt and must be replaced with a new bag or the air (7) entering the negative air apparatus (1) is deemed sufficiently clean. When the bag (3) is half-full, the air flow begins to slow significantly. The light-duty negative air apparatus easily disassembles into a high-velocity air mover (2), an adhesive strip (5), which is replaced after removal, an elastic band (6), and a HEPA filtration bag (3). Although the assembled version is highly portable, disassembly allows even easier transport of the negative air apparatus.

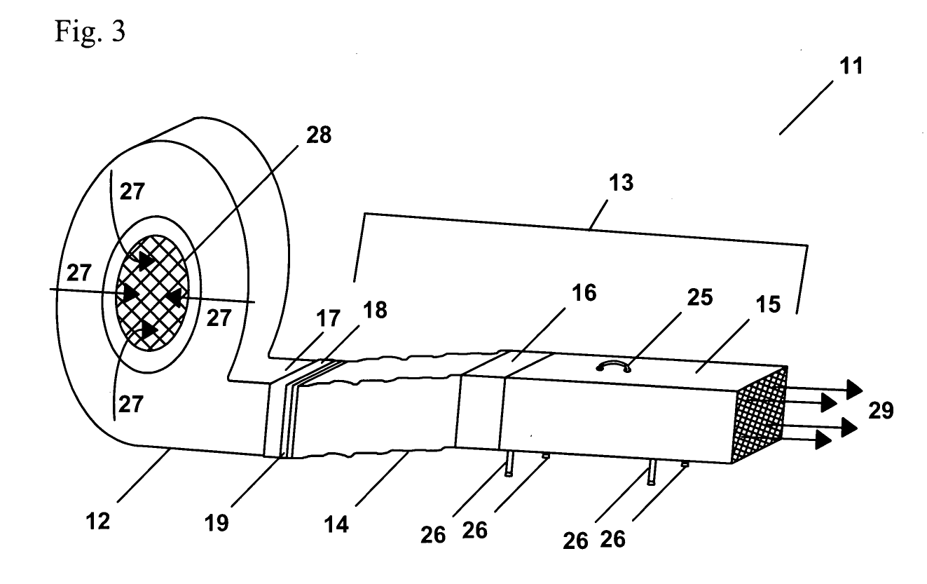

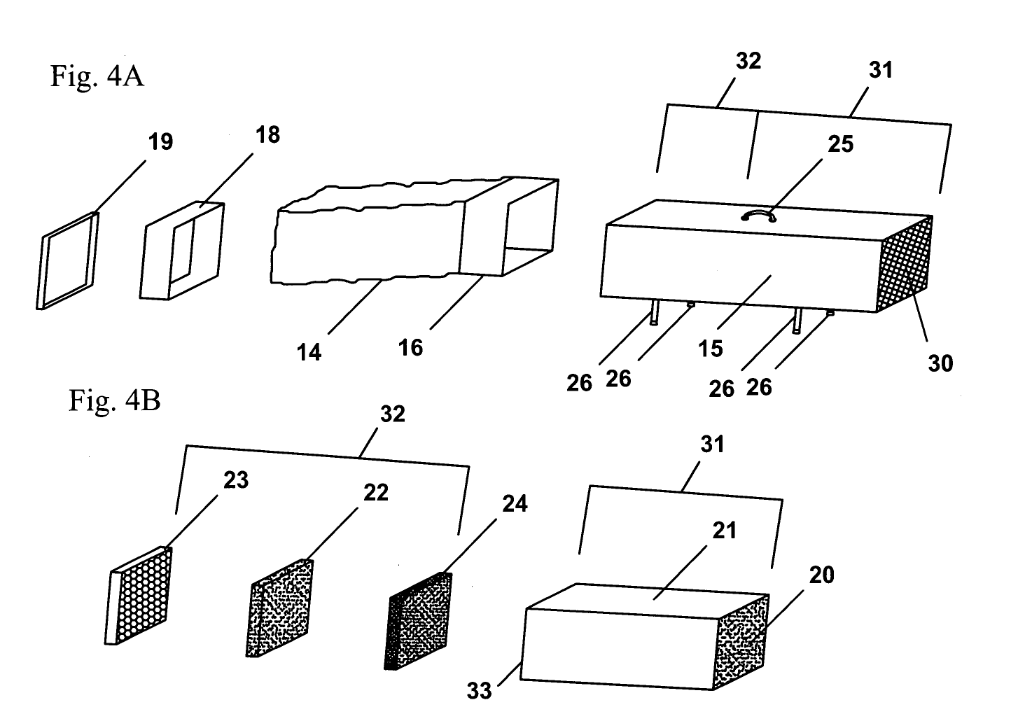

Referring to FIGS. 3, 4A, and 4B, an embodiment of the present invention adapted for heavy-duty air filtration is shown. The heavy-duty negative air apparatus (11) has a stand-alone high-velocity air mover (12) attached to a HEPA filtration unit (13) by way of a flexible, airtight sleeve (14). The shell (15) of the filtration unit is preferably made of metal or a hard plastic and is open to airflow on two opposite ends. The negative air apparatus (11) of the present invention is preferably either a negative air machine or an air scrubber, depending on the industrial application. The sleeve (14) is preferably permanently attached to the shell (15) of the filtration unit (13) internally by an epoxy glue and externally by an adhesive strip (16). The adhesive strip (16) is preferably any adhesive material, including, but not limited to, adhesive tape. Any fastener, which secures the filtration unit to the exhaust vent of the air mover and provides an airtight seal, is within the spirit of the invention. The sleeve (14) is preferably secured over the exhaust vent (17) of the high-velocity air mover (12) with a four-inch wide adhesive strip (18) and an elastic band (19).

The filtration unit (13) contains a HEPA filter (20) at one end of the HEPA filter structure (21). In a preferred embodiment, the filtration unit has a primary filter (22) and a secondary filter (23) placed upstream to the HEPA filter structure (21) for removal of medium and large particles to extend the life of the HEPA filter (20). Optionally, a carbon filter (24) is placed next to the HEPA filter structure (21) for removal of odors from the filtered air. In a preferred embodiment, the shell (15) has a handle (25) attached to the top surface for easy transport. In another preferred embodiment, the shell (15) has a plurality of legs (26) to provide clearance from the floor or surface on which the filtration unit (13) rests during operation of the negative air apparatus.

To operate the negative air apparatus (11), the apparatus is assembled and placed in the space where the air is to be filtered. The high-velocity air mover (12) is turned on. Dirty air (27) is drawn by negative air pressure into the sides (28) of the high-velocity air mover. The dirty air (27) is pushed out the exhaust vent (17) of the air mover and pushed through the filtration materials of the filtration unit (13), where it is filtered and exits the unit as clean, filtered air (29). Air filtration preferably continues, until the primary filter (22) or secondary filter (23) must be cleaned or replaced, the HEPA filter (20) becomes ineffective (typically after about 500 hours of use), or the air (27) entering the negative air apparatus is deemed sufficiently clean.

FIGS. 4A and 4B show an exploded version of the embodiment of FIG. 3. The heavy-duty negative air apparatus easily disassembles into a high-velocity air mover (12), an adhesive strip (18), which is replaced after removal, an elastic band (19), and a HEPA filtration unit (13). The attached sleeve (14) can easily be tucked into the shell (15) of the filtration unit (13). The sleeve (14) at the end of the filtration unit (13) is preferably made of a flexible, airtight material. In a preferred embodiment, the sleeve (14) is made of clear polyethylene tubing of 6 mil. thickness. The sleeve (14) fits around the exhaust vent (17) of any high-velocity air mover. Although the assembled version is highly portable, disassembly allows even easier transport of the negative air apparatus.

The internal components of the filtration unit shell (15) are visible in FIG. 4B. The unit contains a HEPA filter structure (21) that is permanently encased in the shell (15) and located against the outlet end (30) of the filtration unit (13). The HEPA filter structure (21) fills space (31) of the shell (15). The HEPA filter structure (21) has a heavy-duty HEPA filter (20) at the downstream end. In a preferred embodiment, the HEPA filter structure (21) supports one or more removable “pre-filters”, filters located before the HEPA filter in the apparatus, shown as primary filter (22) and secondary filter (23), which take out medium and large particles from the air and extend the life of the heavy-duty HEPA filter (20). These pre-filters are located in the pre-filter space (32) of the shell (15) from the sleeve (14) end to the upstream end (33) of the HEPA filter structure (26). The primary filter (22) is a pleated filter that stops medium size particles from entering the HEPA filter structure (21), which would shorten the useful life of the HEPA filter (20). The secondary filter (23) can be either a foam or fibrous material filter that stops only large particles from entering the primary filter (22) and HEPA filter (20). The primary and secondary filters (22, 23) can be removed and vacuumed once to extend their useful life.

In another preferred embodiment, a carbon filter (24) is optimally placed in the pre-filter space (32) between the upstream end (33) of the HEPA filter structure (21) and the primary filter (22) to remove foul odors from the air. Although the filters have a particular location and order in FIG. 4B, variations to the location, order, and number of the filters are encompassed in the spirit of the present invention. In a preferred embodiment, the carbon filter (24) is used at fire disasters and other work sites where odors affect workers. The HEPA filter (20) lasts for about 500 hours, or three weeks, of operation, and then the entire unit is disposed of and replaced. The apparatus (11) is easily moved into narrow openings and into workspaces, where prior art large negative air machines and air scrubbers could never go. The apparatus (11) also allows more work area for ease of use in confined spaces.

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

1. A conversion kit for converting an air mover including an exhaust vent into an air filtration system having a high efficiency particulate air filtration capacity, said kit comprising:
a) a high efficiency particulate air filtration unit comprising an open end of a size to cover the exhaust vent; and
b) a fastener for attaching the open end of the high efficiency particulate air filtration unit to the exhaust vent, wherein the fastener forms an airtight seal between the exhaust vent of the air mover and the high efficiency particulate air filtration unit.

2. The conversion kit of claim 1, wherein the air mover comprises a stand-alone high-velocity air mover.

3. The conversion kit of claim 1, wherein the air filtration system comprises a negative air apparatus.

4. The conversion kit of claim 1, wherein the fastener is chosen from the group consisting of an elastic band, an adhesive strip, and a combination of the two.

5. The conversion kit of claim 1, wherein the high efficiency particulate air filtration unit further comprises a high efficiency particulate air filtration bag.

6. The conversion kit of claim 1, wherein the high efficiency particulate air filtration unit further comprises:
i) a shell having a first shell end and a second shell end, open to air flow on both ends;
ii) a high efficiency particulate air filter structure having a first structure end and a second structure end and encased in the shell and extending inward from the second shell end and the second structure end;
iii) a high efficiency particulate air filter at the second structure end;
iv) a pre-filter space defined by the shell, the first shell end, and the first structure end; and
v) an airtight sleeve connecting the first shell end to the exhaust vent, wherein the sleeve is secured to the exhaust vent by the fastener.

7. The conversion kit of claim 6, wherein the high efficiency particulate air filtration unit further comprises at least one pre-filter located in the pre-filter space and covering the first structure end.

8. The conversion kit of claim 6, wherein the high efficiency particulate air filtration unit further comprises at least one carbon filter located in the pre-filter space and covering the first structure end.

9. The conversion kit of claim 7, wherein the high efficiency particulate air filtration unit further comprises at least one carbon filter located in the pre-filter space and covering the first structure end.

10. The conversion kit of claim 6, wherein the high efficiency particulate air filtration unit further comprises a handle attached to the shell.

11. The conversion kit of claim 6, wherein the high efficiency particulate air filtration unit further comprises a plurality of legs attached to the shell.

12. A method of converting an air mover into an air filtration system comprising the steps of:
a) providing an air mover including an exhaust vent;
b) providing a fastener;
c) providing a high efficiency particulate air filtration unit; and
d) attaching the high efficiency particulate air filtration unit to the exhaust vent by the fastener, thereby forming an airtight seal between the exhaust vent and the high efficiency particulate air filtration unit.

13. The conversion kit of claim 12, wherein the air mover comprises a stand-alone high-velocity air mover.

14. The conversion kit of claim 12, wherein the air filtration system comprises a negative air apparatus.

15. The method of claim 12, wherein the fastener is chosen from the group consisting of an elastic band, an adhesive strip, and a combination of the two.

16. The method of claim 12, wherein the high efficiency particulate air filtration unit comprises a high efficiency particulate air filtration bag.

17. The method of claim 12, wherein the high efficiency particulate air filtration unit comprises:
i) a shell having a first shell end and a second shell end, open to air flow on both ends;
ii) a high efficiency particulate air filter structure having a first structure end and a second structure end and encased in the shell and extending inward from the second shell end and the second structure end;
iii) a high efficiency particulate air filter at the second structure end;
iv) a pre-filter space defined by the shell, the first shell end, and the first structure end; and
v) an airtight sleeve connecting the first shell end to the exhaust vent, wherein the sleeve is secured to the exhaust vent of the air mover by the fastener.

18. The method of claim 17, wherein the high efficiency particulate air filtration unit further comprises at least one pre-filter located in the pre-filter space and covering the first structure end.

19. The method of claim 17, wherein the high efficiency particulate air filtration unit further comprises at least one carbon filter located in the pre-filter space and covering the first structure end.

20. The method of claim 18, wherein the high efficiency particulate air filtration unit further comprises at least one carbon filter located in the pre-filter space and covering the first structure end.

21. The method of claim 17, wherein the high efficiency particulate air filtration unit further comprises a handle attached to the shell.

22. The method of claim 17, wherein the high efficiency particulate air filtration unit further comprises a plurality of legs attached to the shell.

23. An air filtration system comprising:
a) an air mover including an exhaust vent;
b) a fastener; and
c) a high efficiency particulate air filtration unit comprising an open end covering the exhaust vent and attached to the air mover by the fastener, wherein the fastener forms an airtight seal between the exhaust vent and the high efficiency particulate air filtration unit.

24. The air filtration system of claim 23, wherein the air mover comprises a stand-alone high-velocity air mover.

25. The air filtration system of claim 23, wherein the air filtration system comprises a negative air apparatus.

26. The air filtration system of claim 23, wherein the fastener is chosen from the group consisting of an elastic band, an adhesive strip, and a combination of the two.

27. The air filtration system of claim 23, wherein the high efficiency particulate air filtration unit further comprises a high efficiency particulate air filtration bag.

28. The air filtration system of claim 23, wherein the high efficiency particulate air filtration unit further comprises:
i) a shell having a first shell end and a second shell end, open to air flow on both ends;
ii) a high efficiency particulate air filter structure having a first structure end and a second structure end and encased in the shell and extending inward from the second shell end and the second structure end;
iii) a high efficiency particulate air filter at the second structure end;
iv) a pre-filter space defined by the shell, the first shell end, and the first structure end; and
v) an airtight sleeve connecting the first shell end to the exhaust vent, wherein the sleeve is secured to the air mover by the fastener.

29. The air filtration system of claim 28, wherein the high efficiency particulate air filtration unit further comprises at least one pre-filter located in the pre-filter space and covering the first structure end.

30. The air filtration system of claim 28, wherein the high efficiency particulate air filtration unit further comprises at least one carbon filter located in the pre-filter space and covering the first structure end.

31. The air filtration system of claim 29, wherein the high efficiency particulate air filtration unit further comprises at least one carbon filter located in the pre-filter space and covering the first structure end.

32. The air filtration system of claim 28, wherein the high efficiency particulate air filtration unit further comprises a handle attached to the shell.

33. The air filtration system of claim 28, wherein the high efficiency particulate air filtration unit further comprises a plurality of legs attached to the shell.
